(19) United States
(12) Patent Application Publication
(10) Pub. No.: US 2004/0218047 A1
(43) Pub. Date: Nov. 4, 2004

(54) Entertainment kiosk

(75) Inventors: Jonathan P. Goodman, Voorhees, NJ (US); Gary Falcon, Nashville, TN (US)

Correspondence Address: SYNNESTVEDT & LECHNER, LLP, 2600 ARAMARK TOWER, 1101 MARKET STREET, PHILADELPHIA, PA, 191072950

(73) Assignee: Falcon Management Inc., Nashville, TN

(21) Appl. No.: 10/834,139

(22) Filed: Apr. 28, 2004

Related U.S. Application Data
(60) Provisional application No. 60/466,534, filed on Apr. 29, 2003.
(60) Provisional application No. 60/475,343, filed on Jun. 3, 2003.

(51) Int. Cl. H04N 5/225

(52) U.S. Cl. 348/207.1

(57) ABSTRACT

An entertainment kiosk automatically records a movie of a particular scene and e-mails the movie to selected recipients indicated by a user of the entertainment kiosk. According to another embodiment, the kiosk permits a user to view music tracks stored in memory and select one or more of the music tracks to be downloaded from memory to a portable storage medium for access by the user.

### CROSS-REFERENCE TO RELATED APPLICATIONS

The present patent application claims benefit of U.S. Provisional Application Ser. Nos.60/466,534 and 60/475,343 filed on Apr. 29, 2003 and Jun. 3, 2003, respectively. The contents of the aforementioned applications are fully incorporated by reference herein.

### TECHNICAL FIELD

This invention relates to electronic kiosks.

### BACKGROUND

Electronic kiosks are user-friendly devices that permit users to access information or perform retail-related transactions through the use of a self-serve display screen. For instance, in the realm of information services, kiosks often provide maps, directories, tourism information, travel information, hospitality information, directions to places of interest, and other informational services. In the realm of retail-related transactions, kiosks are often used to dispense cash such as an ATM (automated teller machine), provide self-serve checkout services at stores, provide food menus for ordering food, and so forth.

### SUMMARY

An entertainment kiosk is described herein.

According to one embodiment, the kiosk is configured to automatically record a movie of a particular scene and e-mail the movie to selected recipients indicated by a user of the kiosk. As used herein a “movie” means a digital video clip of a short duration that is directed to a user and/or scene in proximity to one or more cameras integral to the entertainment kiosk. The movie may include video, audio and written text. The scene may be real or virtual. In one implementation, the movies are approximately a minute in length, but could be shorter or longer in length depending on user preferences and/or kiosk parameters.

According to another embodiment, the entertainment kiosk may include the ability to conveniently create digital recordings of audio records and/or movies. For instance, while on vacation or while in a transportation center, a user may desire to select song tracks from the kiosk and record them onto a storage medium, such as a compact disc, digital video disc, non-volatile memory device, digital player or digital recording media for immediate use. The user may select a compilation of songs to be recorded on the various media.

The entertainment kiosk may be used in a myriad of venues, such as, but not limited to, tourist locations, retail locations, restaurants, bars, saloons, amusement parks, zoos, transportation centers, cruise ships, hotels, historic sites, entertainment venues, sporting venues, stadiums, parks, and so forth.

### BRIEF DESCRIPTION OF THE DRAWINGS

The detailed description is described with reference to the accompanying figures. In the figures, the left-most digit(s) of a reference number identifies the figure in which the reference number first appears. It should be noted that the figures are not drawn to scale and are for illustration purposes only.

FIG. 1 illustrates an environment in which an exemplary entertainment kiosk may be used.

FIG. 2 illustrates various components of an exemplary control unit for entertainment kiosk.

FIG. 3 illustrates an exemplary display screen for an entertainment kiosk, which is rendered on a display device.

FIG. 4 illustrates an exemplary display screen presented to a user for entering e-mail address information associated with one or more recipients.

FIG. 5 illustrates an exemplary display screen presented to a user for selection of an optional virtual background scene for a movie.

FIG. 6 illustrates an exemplary display screen presented to a user of the entertainment kiosk confirming information associated with recording a movie.

FIG. 7 is a flow diagram that illustrates an exemplary method to implement a mode of operation associated with recording and e-mailing a movie using a kiosk.

FIG. 8 illustrates an exemplary display screen for selecting music tracks to be stored on portable storage device, such as a CD or a portable digital music player.

FIG. 9 illustrates an exemplary confirmation display screen for showing a compilation of tracks selected by the user.

FIG. 10 is a flow diagram that illustrates an exemplary method to implement a mode of operation associated with selecting music tracks for “burning” onto a CD or other storage media.

### DETAILED DESCRIPTION

Introduction

The following description introduces the broad concept of implementing an entertainment kiosk that permits its users to conveniently send electronic messages, in the form of a short movie (i.e., digital video-clip) to one or more e-mail recipients. As used herein “movie” means a digital video clip of a short duration that is directed to a user and/or scene in proximity to one or more cameras integral to the entertainment kiosk. The movie may include video, audio and written text. The scene may be real or virtual. In one implementation, the movies are approximately a minute in length, but could be shorter or longer in length depending on user preferences and/or kiosk parameters.

The entertainment kiosk may also include the ability to conveniently create digital recordings of audio records and/or movies. For instance, while on vacation or while in a transportation center, a user may desire to select song tracks from the kiosk and record them onto a storage medium, such as a compact disc, digital video disc, non-volatile memory device, digital player or digital recording media for immediate use. The user may select a compilation of songs to be recorded on the various media.

The kiosk may incorporate other features, including but not limited to, advertising on one or more screens of the kiosk, providing a user with the ability to: purchase retail products, search the Internet, access e-mail accounts and web sites, purchase tickets, make voice over Internet protocol (VOIP) connections with real-time streaming video to other recipients, and perform other related functions.

The entertainment kiosk may be used in a myriad of venues, such as, but not limited to, tourist locations, retail locations, restaurants, bars, saloons, amusement parks, zoos, transportation centers, cruise ships, hotels, historic sites, entertainment venues, sporting venues, stadiums, parks, and so forth.

Having introduced some innovative features of an entertainment kiosk, it is possible to provide specific example scenarios of general applications in which the entertainment kiosk may be particularly suited. For instance, imagine a vacationer is sitting on top of mountain in the Swiss Alps enjoying pastries and coffee in a mountain restaurant with family or friends. The vacationer desires to videotape a short clip of the scene and instantaneously convey the clip halfway around the world to coworkers in the United States so they may relish in the adventure. To accomplish this task, today, without the entertainment kiosk described herein, the vacationer will most likely have to possess a videotape camera and the ability to download the video clip to a computer, and then, e-mail the video clip over the Internet. Assuming the vacationer packed a computer and digital video camera, the vacationer may also have to attempt to gain access to the Internet. Chances are, that the process of capturing the moment at the resort restaurant and instantaneously sending the video clip to the vacationer's colleagues is remote given all the equipment needed and various other logistical issues. It is also likely that the vacationer will need to ask a third party to record the video-clip, further adding to the inconvenience.

On the other hand, an entertainment kiosk as described herein, if located on the premises of the Swiss restaurant, would easily provide a means to automatically record a movie, and then instantaneously e-mail the video-clip to any e-mail address selected by the user. Chances are, however, that most vacationers would never consider sending an instantaneous movie via e-mail to anyone while on vacation, because there are no readily available and convenient means to accomplish this task in real-time. Accordingly, it is much more likely that most vacationers will purchase postcards and “snail-mail” it to their colleagues, friends, and/or family.

In another scenario, imagine patrons are in a local bar and would like to capture a fun filled moment by video taping themselves and e-mailing the message to family and/or friends. Currently, there is no readily available way to accomplish this task without performing several layers of tasks that include the use of some type of portable computer device, logging onto the Internet, and capturing the video on a video recording device. It is rare, if not non-existent, to find people in their local bars, going to the trouble of carrying any of these devices on their person to perform the process of capturing a video clip and e-mailing the same to friends and/or family in real-time. And even if the these people were planning on carrying these devices the process of performing the video capture and e-mailing the movies (video clips) is a tedious and inconvenient process today, which usually cannot be performed in a one-stop process in real-time without multiple pieces of equipment and several time-consuming layers of tasks.

On the other hand, an entertainment kiosk as described herein, could be located in a bar or nightclub, permitting patrons to send movies of themselves via e-mail to friends, family, colleagues and/or any other e-mail recipients selected by users of the kiosk.

In another scenario, suppose a child is visiting an amusement park and desires to capture the moment by sending a video-clip of himself to his grandparents. Instead of buying a postcard, the child would prefer to show his grandparents a video-clip of a scene with him in the amusement park. Again, one or more entertainment kiosks could be conveniently located in the amusement park, which for a nominal fee would permit the child to instantaneously send an e-mail of himself to his grandparents, capturing the moment on video. All the child would have to do is pay a fee, input an e-mail address of his grandparents into the kiosk, and stand in front of the kiosk for a short period of time while the kiosk records an audiovisual movie.

In another scenario, suppose a traveler is in an airport and desires to leave a quick video message to a loved-one via e-mail prior to leaving on a plane. For whatever reason, the traveler does not have time to perform the many tasks associated with recording a video, finding someone to shoot the video, logging-on to the Internet, e-mailing the message, packing-up equipment and then catching their plane.

Accordingly, one or more entertainment kiosks could be conveniently located in airports, permitting travelers to instantaneously send movies of themselves to e-mail recipients, by following quick and easy self-serve instructions provided by the entertainment kiosk on a display screen, such as a touch-screen.

Turning now to a different application associated with music, suppose an individual is in an airport and desires to download music to their portable digital music player prior to departing on a plane. To accomplish this task, an individual typically has to use some type of personal computing device to access the Internet, find an Internet site that has an on-line music store and, then, download the music from the site to the digital music player using the personal computing device as a conduit. Without access to a personal computing device (e.g., a portable PC or related device) the individual is most likely not able to access the Internet and download music files in a convenient fashion. This also holds true for burning music files onto a compact disc, but in this case, the personal computing device must include a CD burner. Additionally, the individual must carry with him at least one blank disc on which to record the music files.

Accordingly, the entertainment kiosk may be implemented to permit users to select music tracks, similar to a music jukebox, but create an entire compilation of songs that can either be downloaded onto a portable digital music player (or digital storage device) or burned onto a compact disc and provided to the user. This would be especially convenient to consumers in retail settings such as malls or transportation centers such as airports and train stations.

Exemplary Entertainment Kiosk Environment

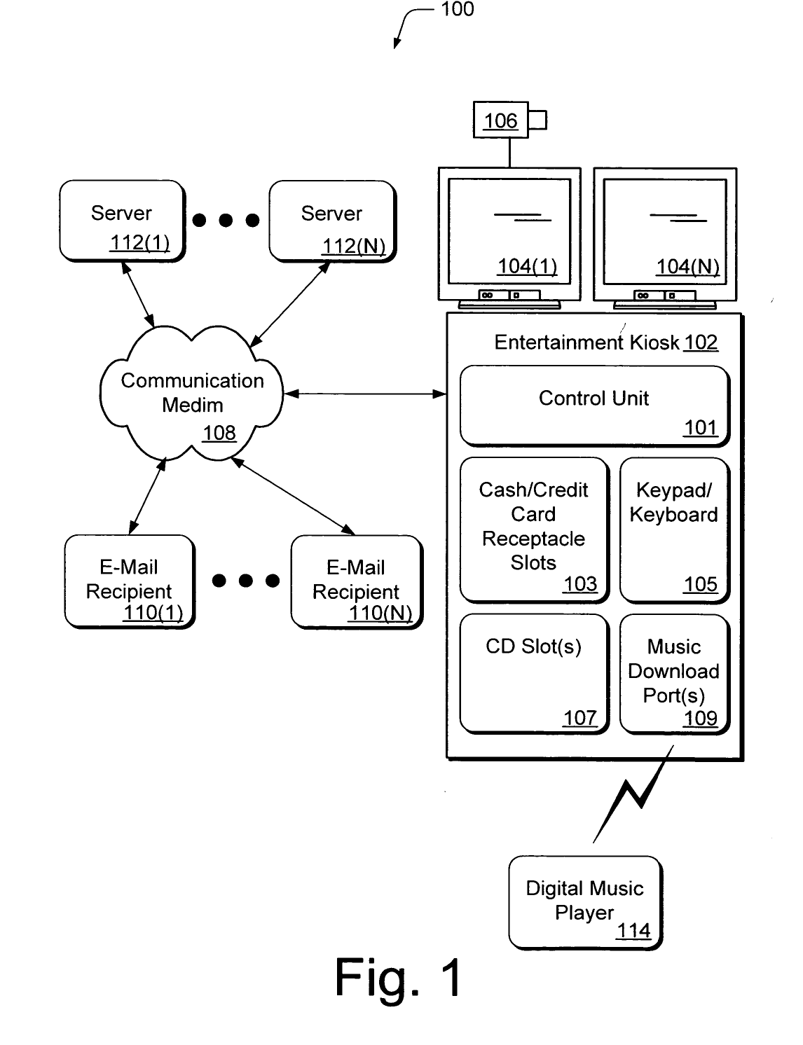

FIG. 1 illustrates an environment 100 in which an exemplary entertainment kiosk 102 may be used. Environment 100 generally represents any public environment, such as, but not limited to, tourist sites, retail locations, restaurants, bars, saloons, amusement parks, zoos, transportation centers, cruise ships, hotels, convention centers, country clubs, ski resorts, golf courses, beaches, boardwalks, lobbies of buildings, exteriors of buildings, on a street, historic sites, entertainment venues, museums, gambling venues, sporting venues, stadiums, parks, and so forth.

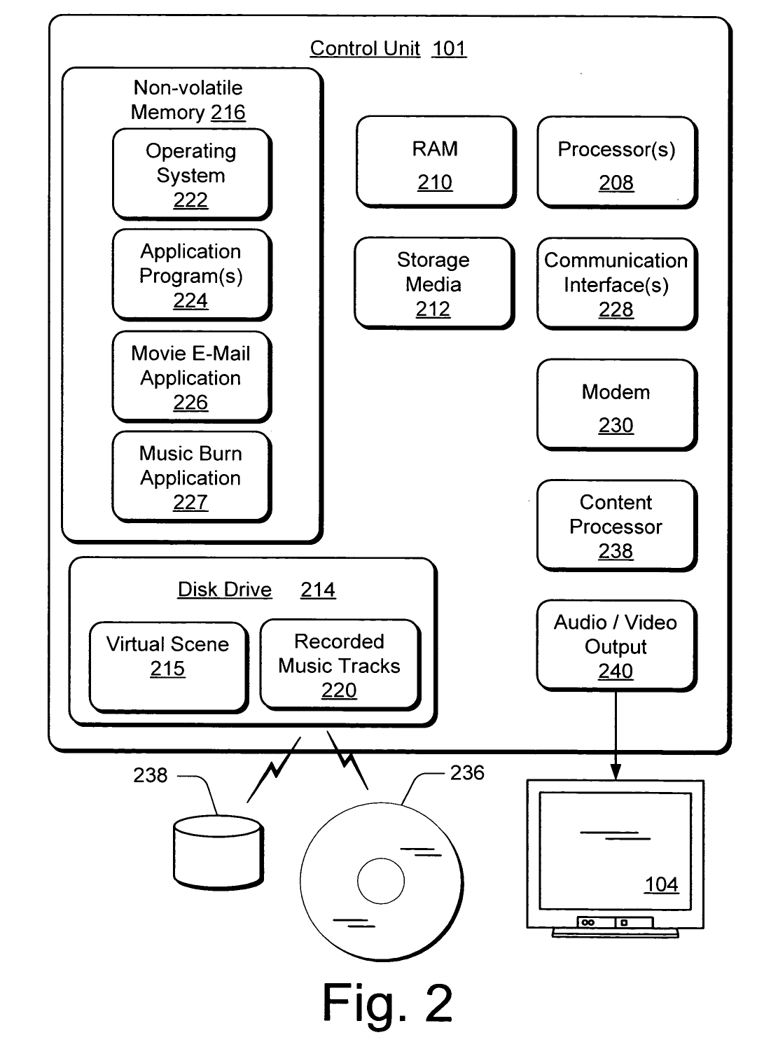

Kiosk 102 can be implemented in any number of embodiments, such as a desktop kiosk, a stand-up kiosk, a booth and as any other type of self-service and user friendly kiosk-styled devices that may be implemented in environment 100. In this example, kiosk includes a control unit 101, which process various instructions to control the operation of kiosk 102 and to communicate with other electronic and computing devices. Control unit 101 will described in more detail with reference to FIG. 2.

Kiosk 102 includes one or more display devices 104(1), . . . , 104(N), which may be any type of display device. In one implementation, at least one display device, referred to generally as reference number 104, is a touch-screen display device capable of displaying visual content including application specific content appurtenant to tasks requested by a user. The visual content may include buttons and instructions that would enable a user to navigate through various menus and controls. Another display device could be used to present advertisements. Display devices 104 may also include speakers (not shown) for dissemination of audio content in conjunction with visual content.

Kiosk 102 may include cash and/or credit card receptacle slots 103, configured to receive cash and/or credit cards, when a user desires to pay for a product or service offered by kiosk 102. For instance, in one implementation cash/credit card respectable slots 103 may include cash and coin acceptors, as well as a credit card reader.

Kiosk 102 may further include keypads and/or keyboards 105 to permit a user to enter information into kiosk 102. The keypad/keyboard 105 may be integrated into the chassis of the kiosk 102.

Kiosk 102 may also include CD (compact disc) slots 107. In one implementation, there is a CD/RW slot for inserting CDs to burn files onto the CD. There may also be a CD dispensing bin for dispensing blank CDs. Kiosk 102 may also include music download ports 109 for connecting to a digital music player 114. These ports may include a “FireWire” connection port, a 1394 port, a USB port, and other various wired and wireless ports used to convey data from one device to another.

In one implementation, at least one video camera 106 is integrated as part of kiosk 102, which is used to record short video segments (also referred to as movies or video-clips) under control of kiosk 102. Camera 106 may be stationary or designed to move and to focus-in on selectable targets. It is envisioned that camera 106 includes one or more microphones (not shown). Alternatively, kiosk 102 may include one or more microphones.

Kiosk 102 may be configured in various shapes and sizes. For example, in one implementation, the kiosk may be in the form of a freestanding screen and chassis. In an alternative implementation, the kiosk may be in the form of a booth, in which users may sit or stand. In one implementation, it is envisioned that many of the internal components will be installed onto racks that reside inside an outer protective casing made of any number of materials including, but not limited to, plastic, metal, and/or wood. It is to be appreciated that additional components can be included in kiosk 102 and some components illustrated in kiosk 102 above need not be included. For example, a ticket dispenser unit could be added which could provide various tickets, such as sports tickets to users; or CD slot(s) 107 may not be included.

Also included in environment 100 is a communication medium 108. The communication medium 108 is intended to represent any of a number of typical communication links including, but not limited to, a proprietary data bus, an industry standard data bus, a local area network (LAN), a wide area network (WAN), global area network (e.g., the Internet), a wireless link, or some type of other communication link. The communication medium 108 permits kiosk 102 to access Internet sites as well as send data (such as e-mail) to e-mail recipients 110(1), . . . , 110(N). Additionally, kiosk 102 may communicate with one or more servers 112(1), . . . , 112(N) via communication medium 108. In one implementation, one or more of the servers referred to generally as reference number 112 may monitor and control some functionality of kiosk 102.

Exemplary Control Unit

FIG. 2 illustrates various components of an exemplary control unit 101 implemented in kiosk 102. Control unit 101 controls the operation of kiosk 102. Control unit 101 also includes one or more processors 208 (e.g., any of microprocessors, controllers, and the like), which process various instructions to control the operation of control unit 101 and to communicate with other electronic and computing devices.

Control unit 101 can be implemented with one or more memory components, examples of which include a random access memory (RAM) 210, mass storage media 212, a disk drive 214, and a non-volatile memory 216 (e.g., ROM, Flash, EPROM, EEPROM, etc.). Disk drive 214 can include any type of magnetic or optical storage device, such as a hard disk drive, a magnetic tape, a rewriteable compact disc, a DVD, and the like. The one or more memory components store various information and/or data such as received content in the form of movies or music tracks downloaded from communication medium 108 (FIG. 1). Alternative implementations of control unit 101 can include a range of processing and memory capabilities, and may include any number of differing memory components than those illustrated in FIG. 2. For example, full-resource kiosks can be implemented with substantial memory and processing resources, whereas low-resource kiosks may have limited processing and memory capabilities.

An operating system 222 and one or more application programs 224 can be stored in non-volatile memory 216 and executed on processor(s) 208 to provide a runtime environment. A runtime environment facilitates extensibility of kiosk 102 by allowing various interfaces to be defined that, in turn, allow application programs 224 to interact with control unit 101. The application programs 224 can include a browser to browse the Web (e.g., “World Wide Web”), an email program to facilitate electronic mailing of movies or other information, and any number of other application programs.

A movie e-mail application 226 that executes on processor(s) 208 is also stored in non-volatile memory 216 and is implemented to permit a user to record movies of a scene in proximity to the camera 106 (FIG. 1). The scene may include one or more people and real or virtual backgrounds. Once the move is recorded (typically in a digital format) it may be temporarily stored in RAM 210, storage media 212 or disk drive 214, until the movie is ready to be transmitted over communication medium 108. The video-clips may be compressed using various data compression algorithms before they are e-mailed to reduce their size. Generally loss-less data compression algorithms are recommended, such as LZW data compression, to avoid poor video and audio quality associated with the video-clips. Movie e-mail application 226 also permits a user to add an optional virtual background to the video-clips. For example, a background for a virtual scene can be created using blue screen, blue box, green screen, and various other virtual screen technologies. One or more virtual scenes 215 are stored on disk drive 214, which may be previewed and selected prior to be included in a movie. Movie e-mail application 226 may also permit users to preview their movies before they are e-mailed as well as to enter e-mail addresses of recipient(s) to receive the video-clips.

A music burn application 227 that executes on processor(s) 208 is also stored in non-volatile memory 216 and is implemented to permit a user to select songs, also referred to as music tracks, for downloading onto a CD 236 or some other form of storage 238 including portable digital music players, such as Apple Computer's iPod portable digital music player. The music tracks may be locally accessible from local memory components (e.g., recorded music tracks 220) for immediate downloading or available offsite via communication medium 108, (FIG. 1) via servers 116. Music burn application 227 generates menu options on display device(s) 104 which enable a user to navigate through an onscreen display and locate songs or albums, and other media access information or content of interest to the user, that a user may desire to down-load onto a storage device in the form of a compact disc 236 or other storages devices 238. Music program application 227 may permit a user to indicate which storage mediums to download the tracks to and a particular data format in which to store the music.

Control unit 101 further includes one or more communication interfaces 228 and a PSTN, DSL, cable, or other type of modem 230. A communication interface 228 can be implemented as a serial and/or parallel interface, as a wireless interface, and/or as any other type of network interface. A wireless interface enables control unit 101 to receive control input commands and other information from a user-operated input device, such as from a remote control device (not shown) or from another infrared (IR), 802.11, Bluetooth, or similar RF input device. Input devices can include a wireless keyboard, a keyboard, an input pad, devices used to administer cash/credit card receptacle slots 103 and CD slot(s) 107, or handheld input devices such as a personal digital assistant (PDA), handheld computer, wireless phone, or the like. A network interface and a serial and/or parallel interfaces enables control unit 101 to interact and communicate with other electronic and computing devices via various communication links including music download ports 109 (FIG. 1) and camera 106 (FIG. 1). Modem 230 facilitates control unit 101 communication with other electronic and computing devices via a conventional telephone line, a DSL connection, cable, and/or other type of connection.

Control unit 101 may also include a content processor 238 which can include a video encoder and/or additional processors to receive, process, and encode recorded video signals including analog video signals, as well as television system digital video signals. For example, content processor 238 can include an MPEG-2 or MPEG-4 (Moving Pictures Experts Group) encoder that encodes MPEG video content and/or image data. The systems described herein can be implemented for any type of video encoding format as well as for data and/or content streams that are not encoded.

Typically, video content and program data includes video data and corresponding audio data. Content processor 238 generates video and/or display content that is formatted for display on display device 104, and generates encoded/decoded audio data that is formatted for presentation by a presentation device, such as one or more speakers (not shown) in display device 104. Content processor 238 can include a display controller (not shown) that processes the video and/or display content to display corresponding images on display device 104. A display controller can include a graphics processor, microcontroller, integrated circuit, and/or similar video processing component to process the images.

Control unit 101 also includes an audio and/or video output 240 that provides the audio, video, and/or display signals to display devices 104 or to other devices that process and/or display, or otherwise render, the audio and video data. Video signals and audio signals can be communicated from control unit 101 to display device 104 via an RF (radio frequency) link, S-video link, composite video link, component video link, or other similar communication link.

Although shown separately, some of the components of control unit 101 may be implemented in an application specific integrated circuit (ASIC). Additionally, a system bus (not shown) typically connects the various components within control unit 101. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Application programs 224 (including movie e-mail application 226 and music burn application 227) execute on processor(s) 208 and can be stored as computer-executable instructions in non-volatile memory 216 of client device 104. Although movie e-mail application 226 and music burn application 227 are illustrated and described as single applications, each can be implemented as several component applications, or received from other devices such as one or more servers 112.

Exemplary System Operation

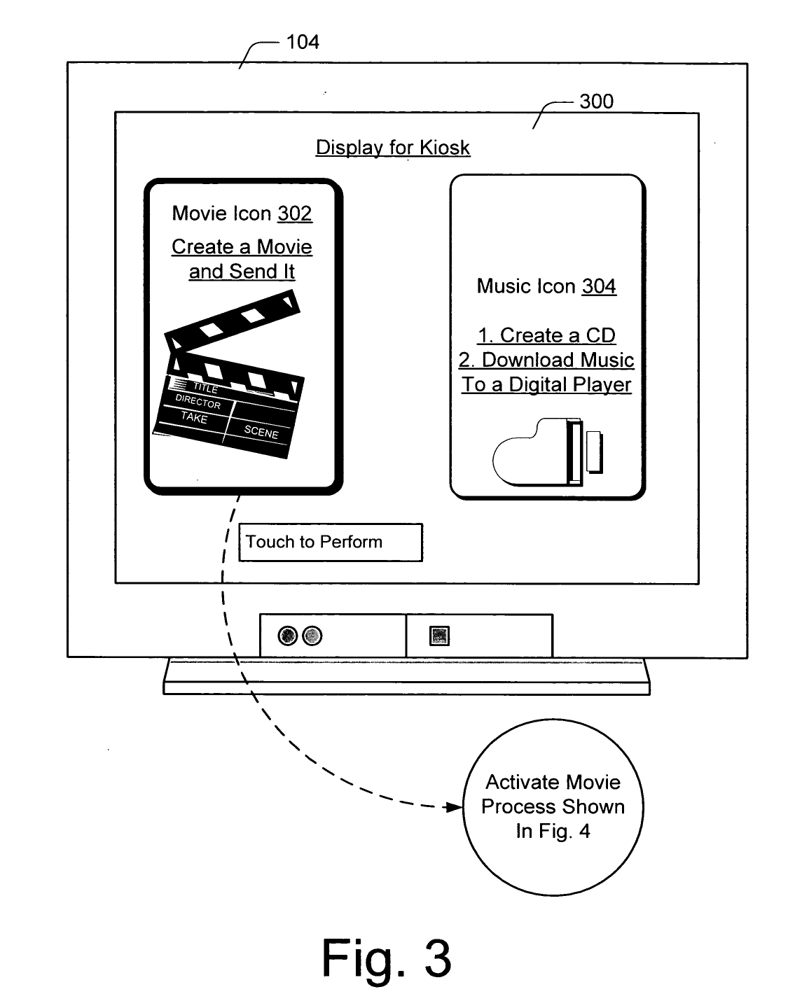

FIG. 3 illustrates an exemplary display screen 300 for kiosk 102, which is rendered on a display device 104 (FIG. 1). Display screen 300 includes a couple of selectable icons: a movie icon 302, and a music icon 304. Selecting movie icon 302 activates a mode of operation for kiosk 102 associated with movie e-mail application 226. Selecting music icon 304 activates a mode of operation associated with music burn application 227. In this example, display device 104 is a touch-screen display device, which permits a user to select any of the icons by simply touching the respective icon. As represented in FIG. 3, a user has selected movie icon 302, which will activate a mode of operation associated with movie e-mail application 226. Accordingly, the next user interface to be displayed by control unit 101 will pertain to recording and e-mailing a movie.

Although only these two icons are shown in FIG. 3, any combination of differing types of additional information can be included in display screen 300 to further inform a user of how to interact with kiosk as well as additional icons associated with purchasing other products, such as tickets, or performing a VOIP conversation using Kiosk 102. Other selectable elements could be used instead of icons such as keypad/keyboard 105, a pointing device (not shown), and/or a mouse (not shown).

Movie E-Mail Application

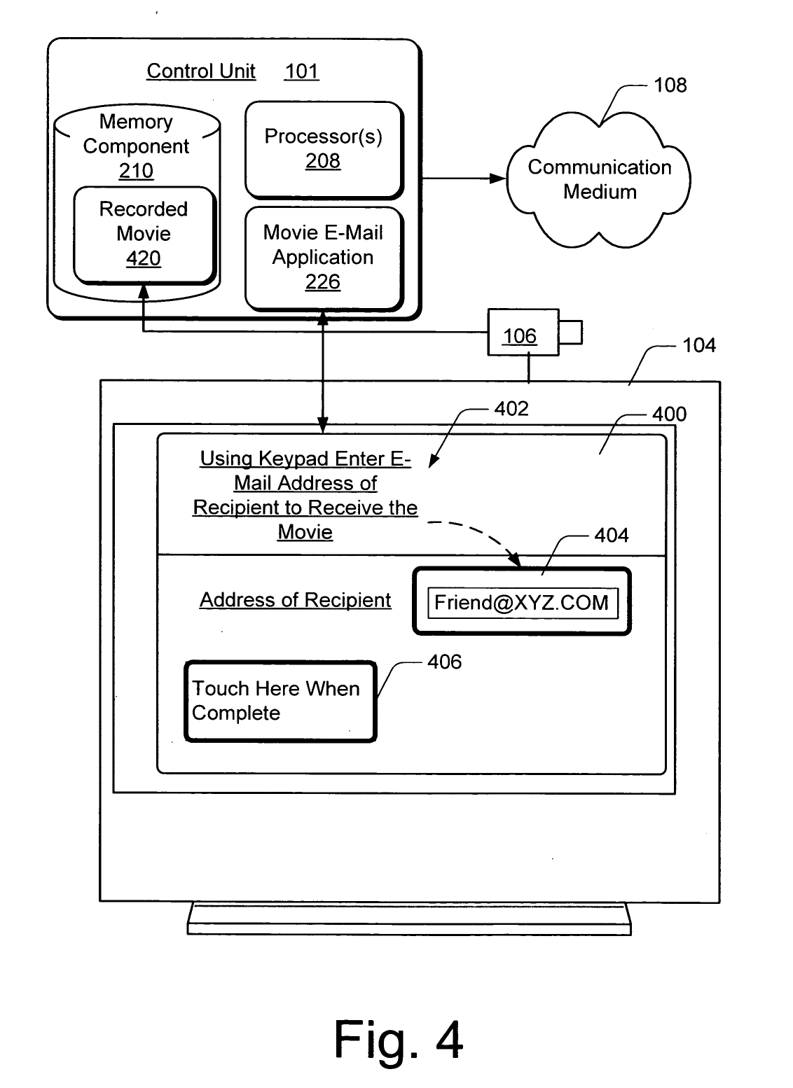

FIG. 4 illustrates an exemplary display screen 400 presented to users for entering e-mail address information associated with one or more recipients. E-mail application 226 executes on processor(s) 208 and is stored as computer-executable instructions in non-volatile memory (see 216 of FIG. 2) of control unit 101. Movie e-mail application 226 is implemented to generate the e-mail address for display in a display region of display device 104. Camera 106 sends a recorded movie 420 to memory component 210 at completion of a recording session, which can then be e-mailed by processor 208 to recipients via communication medium 108.

Display screen 400 may be one of several screens to be displayed after a user selects movie icon 302 in FIG. 3. Display screen 400 includes an instruction 402, an address window 404, and a confirmation icon 406. Instructions shown as reference number 402 direct a user to enter an e-mail address of a recipient to receive a movie. Alternatively, the instructions may be presented to a user in several formats including audio generated instructions.

In this example, the instructions 402 prompt the user to enter the e-mail address in window 404 via keypad/keyboard 105. Alternatively, the user may enter information associated with the e-mail address by other means, such as, but not limited to, a voice recognition system, alphanumeric information displayed on a touch screen, browsing the web, and so forth. Off-the-shelf, software programs may also be used to input one or more addresses, such as Microsoft's® Outlook® or Exchange programs. Although, one e-mail address is shown in window 404, more than one address may be entered at a time in certain implementations.

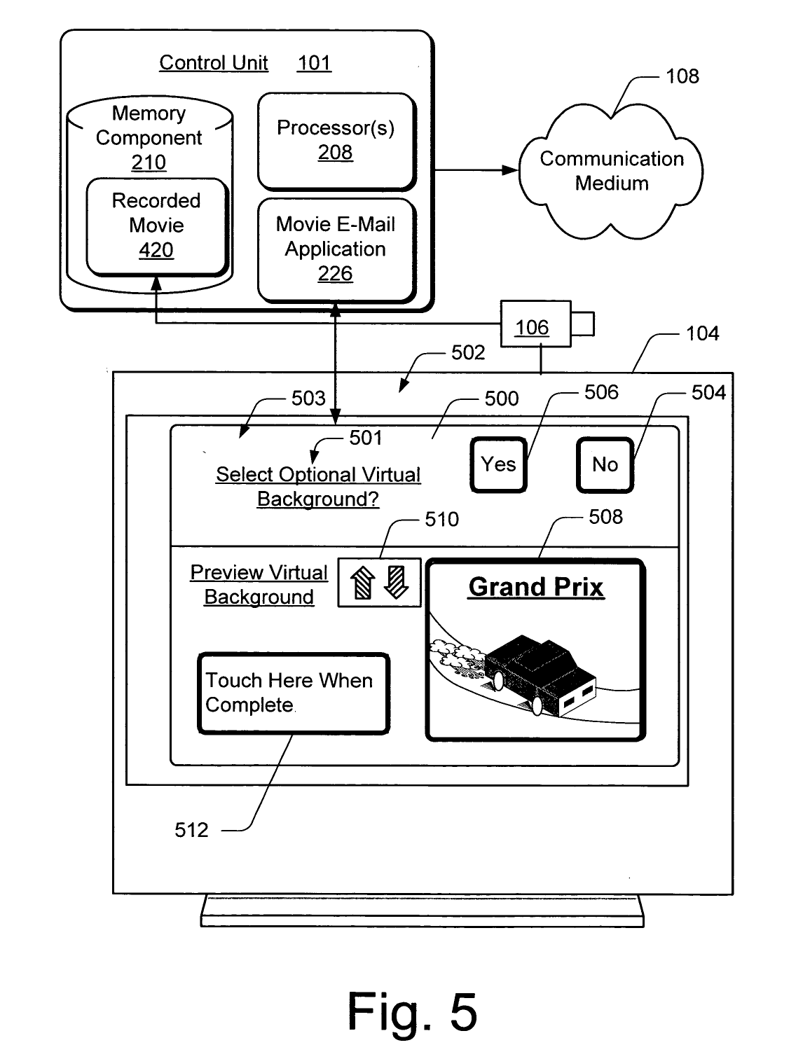

Once the address of at least one recipient is entered into window 404, the user indicates completion of the task by touching confirmation icon 406. At this point the e-mail address depicted in window 404 is sent to a memory component of control unit 101, such as memory component 210, for use when the kiosk is ready to send a recorded movie. After selecting confirmation icon 406, an audio and/or visual indicator may be optionally activated. At this point, a new screen may be rendered or another portion of screen 400 may be presented to the user. Before turning to FIG. 5, it is appreciated that FIG. 4 is only an example of a screen that may be associated with entering e-mail addresses, that some or all of the icons may be displayed in different formats, in different screens, in different order, and with different verbiage.

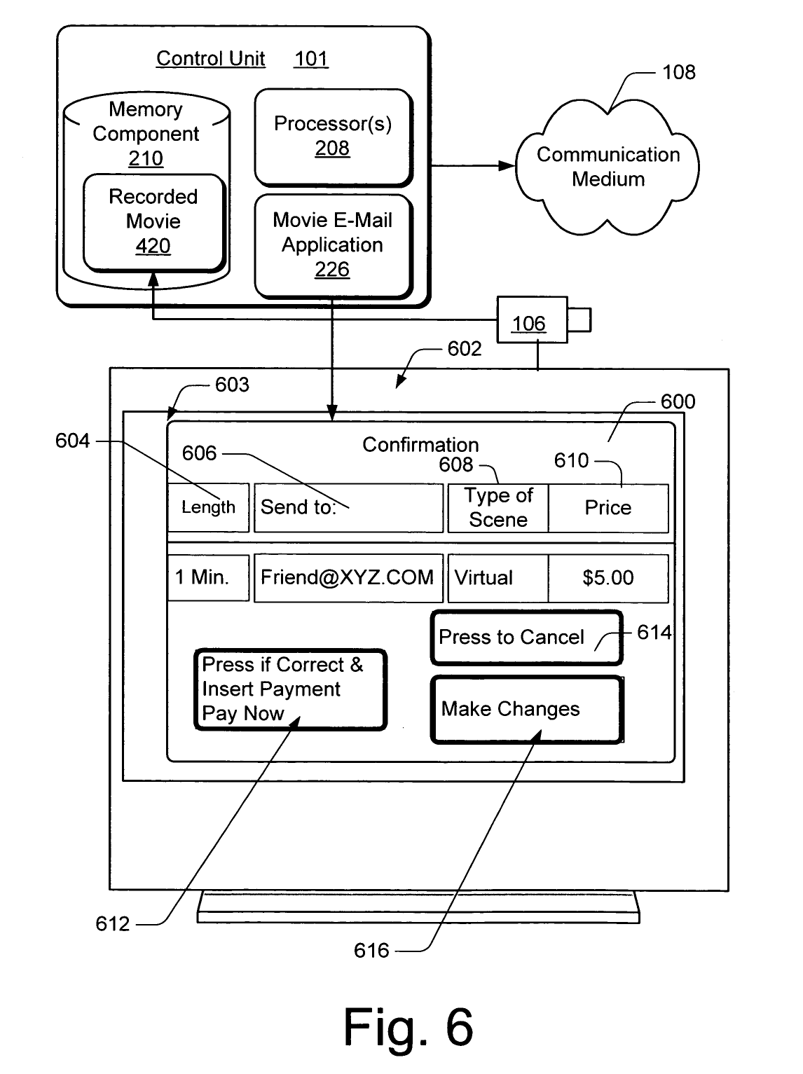

FIG. 5 illustrates an exemplary display screen 500 for kiosk 102 presented to a user for selection of an optional virtual background scene for a movie. In some implementations, the user may not be prompted to choose a virtual scene and a real background scene may be presented by default or vice versa. In particular, display 500 shows a virtual background selection screen 502 presented to a user to preview before (or after) recording a movie. Referring to display region 503, the selection screen 502 includes a question 501 presented to a user asking whether the user desires a real background (i.e., the actual background of a scene in view of the camera) or a virtual background to be included in the movie. The user may accept or decline to use the virtual background by selecting either the “Yes” icon 506 or the “No” icon 504, respectively. If the user selects the “No” icon 504, movie e-mail application 226 presents a next screen (or another portion of screen 500) such as shown in FIG. 6.

If the user selects the “Yes” icon 506, then the user is able to preview one or more virtual scenes presented in a preview window 508 as a static or dynamic background. A user can move selectable control 510 within screen 500 to generate different virtual scene selections, such as by manipulating up and down arrows in selectable control 510. Additionally, the virtual scenes may be depicted in several display windows and can be selected by selecting the windows by touching the screen or by other selection means such as a pointing device as described above. Once again, the virtual scene can be created using blue screen, blue box, green screen, and various other virtual screen technologies.

Once the virtual scene is chosen in preview window 508, the user indicates completion of the selection by touching confirmation icon 512. At this point the virtual scene 215 (FIG. 2) selected in preview window 508 can be read from memory (such as disk drive 214) at the appropriate time so that it is included in a movie. The screen depicted in FIG. 5 is only an example a screen that may be associated with choosing a virtual scene. Some or all of the icons may be displayed in different formats, in different screens, in different order, and with different verbiage.

FIG. 6 illustrates an exemplary display screen 600 presented to a user of confirming information associated with recording a movie. In particular, display 600 shows a confirmation screen 602 presented to a user to prior to recording a movie. Referring to display region 603, the confirmation screen 602 includes a length identifier 604, a recipient e-mail address identifier 606, a scene identifier 608, and price identifier 610. Length identifier 604 indicates the length of a move to be recorded, which in this example is one minute. The user may choose the length of a movie may be set by default (e.g., one minute). E-mail address identifier 606 indicates one or more e-mail addresses for recipients to receive the movie via e-mail, e.g., “Friend@XYZ.COM. Type of scene identifier 608 indicates whether the background is a virtual or real scene, which in this example is virtual. And price identifier 610 indicates the fee requested to record and e-mail the movie. The fee may increase depending on a number of factors such as the length of movie selected, quantity of recipients chosen to receive the movie, and/or whether a virtual or real scene is selected. Alternatively, the price could be fixed. Additional fee parameters may be used to determine the final price of a particular movie.

Also shown in confirmation screen 602 are selectable icons 612, 614 and 616. To confirm the information displayed in confirmation screen and make a payment the user would select pay-now icon 612. To cancel the session, the user would press cancel icon 614. And to correct or change information, the user would press correction icon 616. It is appreciated that FIG. 6 is only an example confirmation screen. Some or all of the icons may be displayed in different formats, in different screens, in different order, and with different verbiage. It is also appreciated that a confirmation screen 602 is optional and may not be presented in certain implementations.

Methods for Recording and Sending Movies

Methods for movie e-mail application 226 may be described in the general context of computer-executable instructions. Generally, computer-executable instructions include routines, programs, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

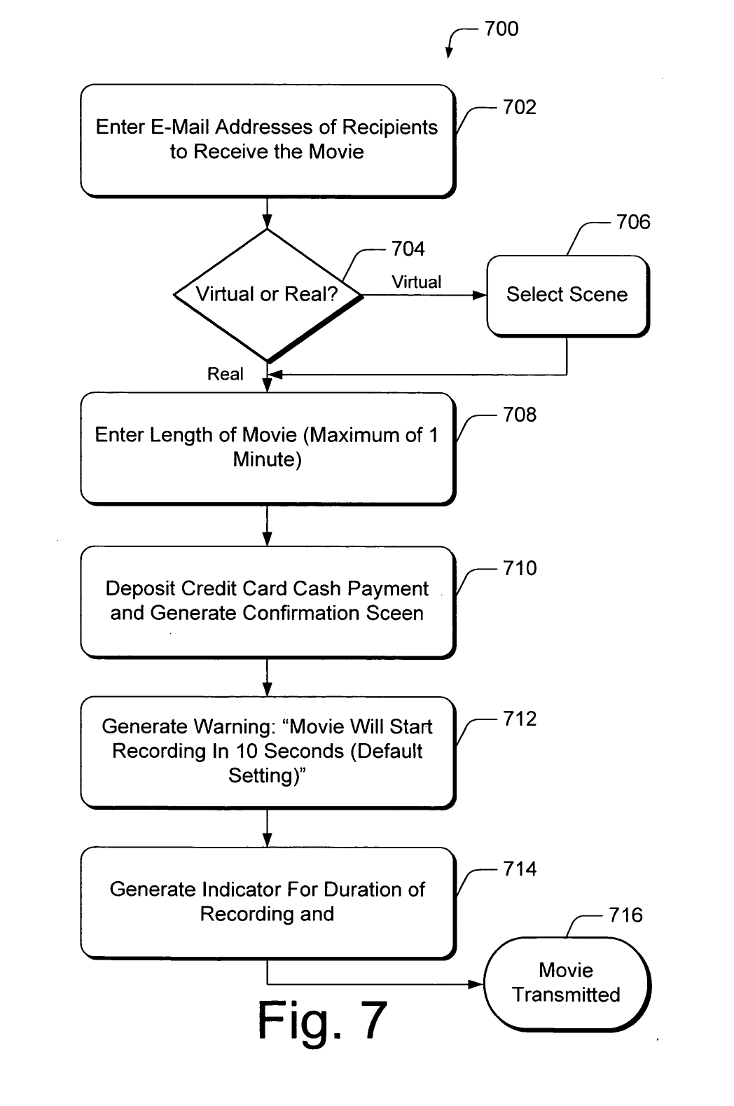

FIG. 7 is a flow diagram that illustrates an exemplary method to implement a mode of operation associated with recording and e-mailing a movie using kiosk 102. The order in which the method is described is not intended to be construed as a limitation, and any number of the described method blocks can be combined in any order to implement the method. Furthermore, the method can be implemented in any suitable hardware, software, firmware, or combination thereof. Method 700 includes blocks 702 through 716.

In block 702, a display screen on display device 104 requests that a user enter e-mail addresses of recipients to receive a movie to be recorded by kiosk 102. In one implementation, the user may be restricted to a maximum number of entries per recording session, such as a maximum of five recipients. The e-mail address may be entered by keypad/keyboard 105. Alternatively, the e-mail addresses could be entered through a touch screen listing (not shown), voice command system (not shown), or remote control device (not shown). Screen 400 in FIG. 4 shows one example way that information may be presented to a user to gather recipient addresses from a user of kiosk 102

In block 704, a display screen on display device 104 queries the user whether they would like select an actual background or virtual background. A virtual background refers to a scene that was prerecorded from a different location, such as of a mountain, or was computer generated such as of a virtual animation. If according to the “Virtual” branch of decisional block 704, a virtual scene is selected, method 700 proceeds to block 706. In block 706, the user may be presented with one or more virtual scenes to be displayed behind the subjects of the movie. For example, if the user selects a ski resort virtual scene, the subjects of the movie will appear to be present on the ski resort. The users may scroll through and potentially preview the scenes on display device 104 before selecting one. If no virtual scene is offered by kiosk 102, then blocks 704 and 706 are not required as part of process 700. If according the “Real” branch of decisional block 704, method 700 proceeds to block 708. Screen 500 shows one exemplary display presented to a user for selecting a virtual or real background.

In block 708, irrespective or whether a real or virtual scene was selected, the user may be prompted to enter the duration for a movie. Typically, movies to be recorded should not exceed a certain preset duration; otherwise the size of a digital file needed to send the movie may be too large to be e-mailed. The duration may also be a default parameter in which the user has no control such as a minute movie, in which case block 708 is potentially not required as part of process 700.

In block 710, a user is prompted to pay for the movie before the move is recorded. For example, the user is prompted to deposit cash or a credit card in cash/credit card recepetacable slots 103. Before depositing the payment, the user may be presented with a confirmation screen. For example, FIG. 6 shows a confirmation screen.

In block 712, a display is rendered that warns the user that the movie camera 106 will begin recording a movie in the immediate future such as according to a default setting (e.g., 10 seconds). Alternatively, the user may have the ability to initiate the start of a movie by depressing a button on the kiosk or by using a remote control device (not shown). The user may also be instructed on where to stand or sit so that the camera is able to focus on to the subjects of the movie. Alternatively, the user may have control of camera 106 through a keypad/keyboard 106, a joystick (not shown), a remote control device (not shown), which could direct camera 106 to scan a particular scene and or zoom-in or out of a particular area. It may also be possible to view the scene as it is recorded by camera 106 on display screens 104.

In block 714, kiosk generates an indicator for the duration of the recording of the movie. This indicator permits the subjects of the movie to know when the recording has commenced and ended. For example, a red light (not shown) on the top of camera 106 could indicate that the camera is recording. Alternatively, one of the display devices 104 could display a message that the recording is in session. At the conclusion of recording the indicator will deactivate, indicating that the recording session is over. Audio instructions or indicators may also be used with or without visual indicators.

In block 716, the kiosk generates some type of indication that the movies were transmitted over communication medium 108. If for some reason they were improperly sent, and a bad address reply is received, the kiosk may prompt the user to re-enter the e-mail address and attempt to resend the movie. Operations performed in block 716 are optional.

Music Burn Application

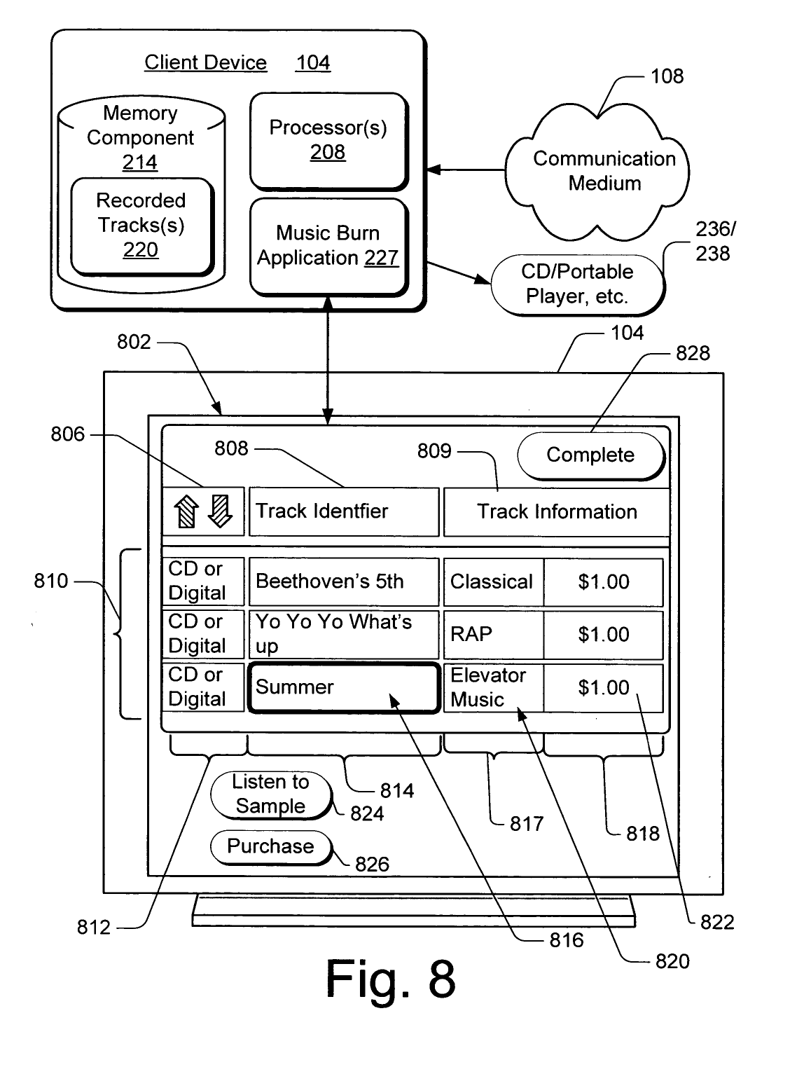

FIG. 8 illustrates an exemplary display screen 802 for selecting music tracks to be stored on portable storage device, such as a CD 236 or a portable digital music player 238. In particular, display screen 802 provides a user selectable menu, which permits the user to browse and select music tracks. Screen 802 includes a selectable control 806, a track identifier 808, and a track information identifier 809. Selectable control 806 permits the user to scroll up or down through a listing of music tracks 810. For example, up and down arrows on a touch screen device may be manipulated to view different music tracks 810. Alternatively, selectable control 806 may be implemented using other selection means, including pointing devices, mouse, track balls, joy sticks, buttons, and so forth.

Track identifier 808 lists the titles of songs (i.e., tracks) in a column 814. Track information identifier 809 includes a column 817 indicating what genre of music each particular track falls-in, such as rap, classical, pop, jazz, etc. Track information identifier 809 also includes a fee column 818 showing fees associated with each particular track.

A user may select one or more particular tracks by selecting the icon associated with a particular track. For example, a user may select the song “Summer” by touching the icon 816 associated with the song “Summer.” In this example, when a track is selected, the icon is highlighted as indicated with respect to icon 816. The user is presented with information indicating that this is song is associated elevator music per icon 820 and costs one dollar per icon 822. The user may also select whether to send the track to a CD 236 or other storage medium238 such as a portable digital player by selecting “CD” or “Digital” in icons located in column 812.

It is also possible that a user may preview a track by listening to a short sample of the song before purchasing it. In one implementation, this is accomplished by selecting “Listen to Sample” icon 824. The user may purchase a track by touching the icon associated with the track (such as highlighted icon 816) and then selecting purchase icon 826. In certain implementations, this may be accomplished in one step by simply selecting the particular icon associated with a song, such as icon 816.

At completion of selecting a certain quantity of songs to be downloaded on to a storage medium, the user selects the completion icon 828, which indicates that no more tracks are going to be selected by the user. Music burn application 227 may control how many total songs may be selected depending on the amount of storage space available on a particular medium. Accordingly, by monitoring the size of each particular track, music burn application 227 is able to determine a maximum quantity of songs that can be purchased for a particular storage medium 236/238. It is also possible that default settings may be loaded into music burn application 227 limiting the quantity of tracks to a certain number per medium, such as for example: a maximum of ten pop tracks per medium; two classical tracks per medium; three jazz tracks per medium; and so forth.

It is appreciated that FIG. 8 is only an example screen used to purchase music tracks for downloading onto a storage medium 236/238. Some or all of the icons may be displayed in different formats, in different screens, in different order, and with different verbiage. It is also appreciated that some icons are optional and may not be included in certain applications.

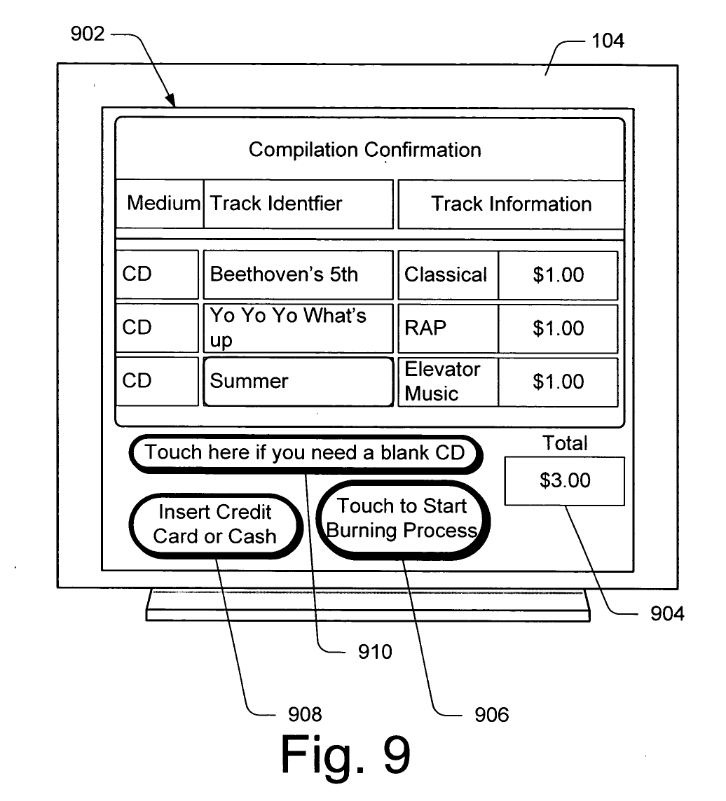

Upon selecting completion icon 828, music burn application 227 presents the user with a confirmation screen. FIG. 9 illustrates an exemplary confirmation display screen 902 displaying a compilation of tracks selected by the user. In particular, display screen 902 provides a listing of all the tracks selected, the medium onto which they will burned, the type of genre each track falls under, and the total price for the purchase (indicated in fee window 904). At this point the user is instructed to insert cash or a credit card to pay for the tracks as indicated in instruction window 908.

Once payment is inserted and accepted by kiosk 102, the user may select burn icon 906 to start the downloading process. At this point, the user may insert a blank CD in slot 107 and according to the example of FIG. 9, three songs will be burned onto a compact disc 236. At completion of the burning process the CD is output to the user via CD slot 107. It should be noted that the user might purchase various storage media prior to downloading the tracks. In this example, the user may purchase blank CDs by touching icon 910 providing the option to purchase a blank CD. The cost of the blank CD will then be added automatically to the total fee shown in fee window 904. The blank CD will also be output to the user via CD slot 107.

Methods for Purchasin2 Music from Kiosk 102

Methods for selecting and purchasing tracks of music may be described in the general context of computer-executable instructions. Generally, computer-executable instructions include routines, programs, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

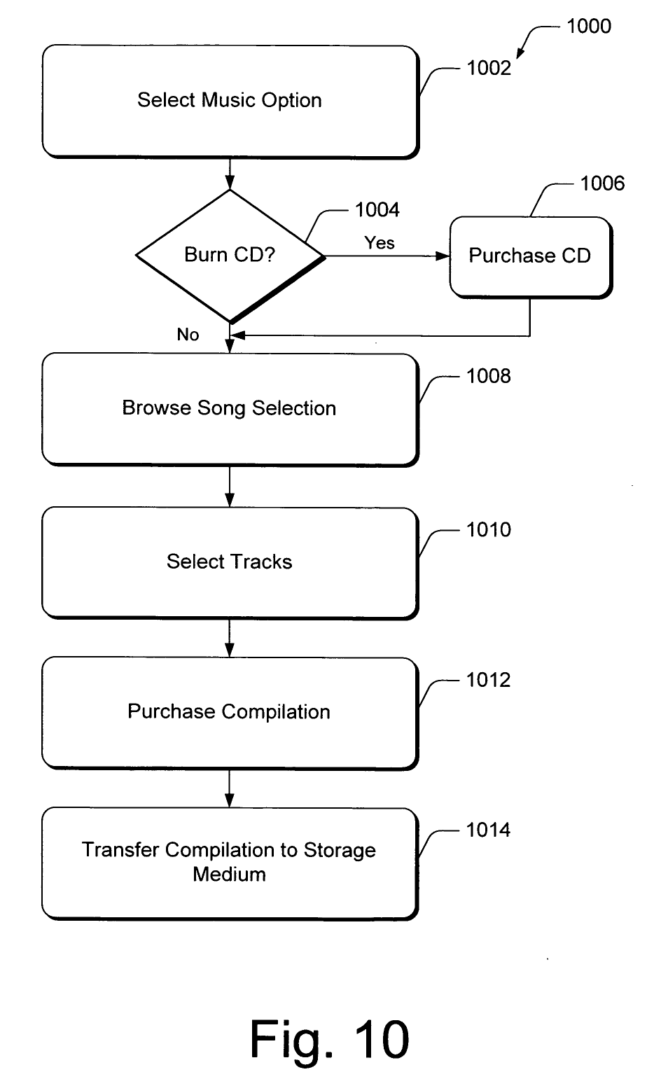

FIG. 10 illustrates a method 1000 to implement a mode of operation for kiosk 102 associated with music burn application 227. The order in which the method is described is not intended to be construed as a limitation, and any number of the described method blocks can be combined in any order to implement the method. Furthermore, the method can be implemented in any suitable hardware, software, firmware, or combination thereof. Method 1000 includes blocks 1002 through 1014.

In block 1002, process 1000 is initiated by user commands. For example, the user may launch process 1000 by selecting music icon 304 (FIG. 3). In block 1004, process 1000 determines whether the user desires to download music to a CD or portable digital music player (or possibly some other type of storage medium). This may be accomplished by requesting the user indicate which medium the user intends to write the digital data. If according to the Yes branch of decisional block 1004, the user desires to create a CD, then process 1000 proceeds to block 1006.

According to block 1006, the user may purchase a blank CD from kiosk 102. Once the user purchases the CD or if the user has portable digital player, the user may select songs, in accordance with block 1008. The user may browse songs from local memory within a kiosk or from an Internet site. In most instances, tracks may be viewed and read from a local storage medium quicker than from remotes sites over the Internet.

In block 1010 the user selects one or more tracks to be included in a compilation of one or more songs. The user may be limited to the quantity of tracks that may be selected in block 1010, based on song size, default parameters, and/or the type of storage medium the songs are to be written-to. In block 1012, the user confirms that the selection process is complete and purchases the compilation by depositing a payment via cash, credit card, or some other payment method. In block 1014, once payment is received, process 1000 transfers music data associated with the compilation to the storage medium.

Although some implementations of the various methods and arrangements of the present invention have been illustrated in the accompanying Drawings and described in the foregoing Detailed Description, it will be understood that the invention is not limited to the exemplary aspects disclosed, but is capable of numerous rearrangements, modifications and substitutions without departing from the spirit of the invention as set forth and defined by the following claims.

What is claimed is:

1. An apparatus, comprising: a kiosk configured to automatically record a movie of a particular scene and e-mail the movie to selected recipients indicated by a user of the kiosk.

2. The apparatus as recited in claim 1, wherein the kiosk is located in a user accessible venue including at least one of a tourist location, a retail location, a restaurant, a bar, a saloon, an amusement park, a zoo, a transportation center, a cruise ship, a hotel, an historic site, an entertainment venue, a sporting venue, a stadium, and a park.

3. The apparatus as recited in claim 1, wherein the kiosk comprises a camera, configured to record the movie of the particular scene in proximity to the camera.

4. The apparatus as recited in claim 1, wherein the movie is a digital video clip of a short duration that is directed to at least one of a user and a scene in proximity to the kiosk.

5. The apparatus as recited in claim 1, wherein the movie is a digital video clip of a short duration that is directed to at least one of a user and a scene in proximity to the kiosk, the movie including at least one of video, audio, and written text.

6. The apparatus as recited in claim 1, wherein the movie is a digital video clip of a short duration that is directed to at least one of a user and a scene in proximity to the kiosk, the scene being at least one of a real and virtual scene.

7. A kiosk, comprising:
a camera, configured to record a movie of a scene in proximity to the camera,
a user interface, configured to permit a user to enter one or more e-mail addresses of recipients to receive the movie via e-mail; and
a control unit, configured to cause the camera to automatically record the movie and then e-mail the movie to the recipients.

8. The kiosk as recited in claim 7, wherein the kiosk is located in a user accessible venue including at least one of a tourist location, a retail location, a restaurant, a bar, a saloon, an amusement park, a zoo, a transportation center, a cruise ship, a hotel, an historic site, an entertainment venue, a sporting venue, a stadium, and a park.

9. The kiosk as recited in claim 7, wherein the movie is a digital video clip of a short duration that is directed to at least one of a user and a scene in proximity to the kiosk.

10. One or more computer readable media having stored thereon a plurality of instructions that, when executed by one or more processors of a kiosk, causes the kiosk to:
automatically record a movie of a particular scene; and
e-mail the movie to selected recipients indicated by a user of the kiosk.

11. One or more computer readable media as recited in claim 10, having stored thereon a plurality of instructions that, when executed by one or more processors of the kiosk, further causes the kiosk to: prompt the user to enter e-mail addresses of recipients to receive the movie recorded by the kiosk.

12. One or more computer readable media as recited in claim 10, having stored thereon a plurality of instructions that, when executed by one or more processors of the kiosk, further causes the kiosk to: prompt the user to enter e-mail addresses of recipients to receive the movie recorded by the kiosk.

13. One or more computer readable media as recited in claim 10, having stored thereon a plurality of instructions that, when executed by one or more processors of the kiosk, further causes the kiosk to: prompt the user to select at least one of an actual background or virtual background for the movie, wherein the actual background includes an actual scene recorded by a camera in proximity to the kiosk and the virtual background includes a scene that was prerecorded from a different location, or was computer generated.

14. A method, comprising:
requesting that a user enter an e-mail address of a recipient to receive a movie to be recorded by the kiosk;
recording the movie; and
transmitting the movie to the recipient.

15. The method as recited in claim 14, querying the user to select an actual background or virtual background for the movie.

16. The method as recited in claim 14, wherein the movie is a digital video clip of a short duration that is directed to at least one of a user and a scene in proximity to the kiosk.

17. The method as recited in claim 14, displaying a screen on a display device of a kiosk instructions indicating how a user may record and e-mail movies to one or more recipients.

18. A kiosk, comprising:
a user interface, configured to permit a user to view music tracks and select one or more of the music tracks; and
a control unit, configured to cause the one or more selected music tracks to be copied to a portable storage medium for access by the user.

19. The kiosk as recited in claim 18, further comprising a memory device configured to store the music tracks.

20. The kiosk as a recited in claim 18, wherein the one or more music tracks are viewed and selected by the user based on titles of the one or more music tracks.

21. The kiosk as recited in claim 18, wherein the kiosk is located in a user accessible venue including at least one of a tourist location, a retail location, a restaurant, a bar, a saloon, an amusement park, a zoo, a transportation center, a cruise ship, a hotel, an historic site, an entertainment venue, a sporting venue, a stadium, and a park.

22. The kiosk as recited in claim 18, wherein the portable storage medium comprises at least one of a compact disc, a portable digital music player, and flash memory.

23. A method, comprising:
enabling a user to view music tracks from a display screen of a kiosk;
enabling the user to select one or more of the music tracks from the display screen of the kiosk;
enabling the one or more selected music tracks to be copied from the kiosk to a portable storage medium for use by the user.

24. The method as recited in claim 22, wherein the kiosk is located in a user accessible venue including at least one of a tourist location, a retail location, a restaurant, a bar, a saloon, an amusement park, a zoo, a transportation center, a cruise ship, a hotel, an historic site, an entertainment venue, a sporting venue, a stadium, and a park.

25. The method as recited in claim 22, wherein the portable storage medium comprises at least one of a compact disc, a portable digital music player, and flash memory.

26. One or more computer readable media having stored thereon a plurality of instructions that, when executed by one or more processors of a kiosk, causes the kiosk to:
enable a user to view music tracks from a display screen of a kiosk;
enable the user to select one or more of the music tracks from the display screen of the kiosk;
enable the one or more selected music tracks to be copied from the kiosk to a portable storage medium for use by the user.

27. A kiosk, comprising:
means for enabling a user to browse a music selection offering;
means for enabling the user to select music tracks from the music selection offering; and
means for transferring the selected music tracks to a portable storage medium for use by the user.

28. A kiosk, comprising:
a user interface, configured to permit a user to view movie titles stored in memory and select one or more of the movies associated with the movie titles to be downloaded from memory to a portable storage medium for access by the user; and
a control unit, configured to cause the one or more selected movies to be copied from memory to the portable storage medium.

29. The kiosk as recited in claim 28, wherein memory is accessible to the kiosk via a communication medium.

30. The kiosk as a recited in claim 28, wherein memory resides in the kiosk.

31. The kiosk as recited in claim 28, wherein the kiosk is located in a user accessible venue including at least one of a tourist location, a retail location, a restaurant, a bar, a saloon, an amusement park, a zoo, a transportation center, a cruise ship, a hotel, an historic site, an entertainment venue, a sporting venue, a statium, and a park.

32. The kiosk as recited in claim 28, wherein the portable storage medium comprises at least one of a compact disc, a portable digital music player, and flash memory.
